(19) United States
(12) Patent Application Publication
(10) Pub. No.: US 2021/0138775 A1
(43) Pub. Date: May 13, 2021

(54) FILMS FOR PACKAGING OF FOODSTUFFS

(71) Applicant: CSIR, Pretoria (ZA)

(72) Inventors: Jayita BANDYOPADHYAY, Pretoria (ZA); Mary KHOZA, Rustenburg (ZA); Rakgoshi K. LEKALAKALA, Midrand (ZA); Lesley MAPOKO, Soshanguve (ZA); Mpho MOTLOUNG, Benoni (ZA); Vincent OJIJO, Pretoria (ZA); Suprakas Sinha RAY, Pretoria (ZA); Manfred SCRIBA, Pretoria (ZA); Sifiso SKOSANA, Mpumalanga (ZA); Simphiwe ZUNGU, Dundee (ZA)

(21) Appl. No.: 16/682,618

(22) Filed: Nov. 13, 2019

(51) Int. Cl. B32B 27/20; B32B 27/32; B32B 27/34; B32B 27/08; B65D 65/40; B65D 81/24; B65D 77/06

(52) U.S. Cl. CPC B32B 27/20; B32B 27/32; B32B 27/34; B32B 27/08; B65D 65/40; B32B 2264/107; B65D 77/062; B32B 2264/10; B32B 2439/46; B32B 2439/70; B65D 81/24

(57) ABSTRACT

Some embodiments provide a composite active flexible polymeric film. In some embodiments, the film is used for containers containing acidic material. In some embodiments, the film generates carbon dioxide gas when in contact with the acidic material to settle in the headspace of the container.

### TECHNICAL FIELD

This invention relates to films for packaging of foodstuffs.

### BACKGROUND

Flexible films may be used for packaging foodstuffs such as wine and fruit juice. Such packaging of liquid foodstuffs are often also packaged and supported in a box and known as “Bag-in-Box” packaging. Typically, the main oxygen barrier will be an aluminium film layer however, this layer is prone to damage during transport and is not recyclable and not transparent which prevents the foodstuffs being visible through the film. The main objective of the films is to extend the shelf life of the foodstuffs for as long as possible by limiting exposure of the foodstuffs to oxygen, light and microorganisms.

### SUMMARY

It is an objective of the invention to provide films for packaging foodstuffs with improved shelf life. According to some embodiments there is provided a composite active flexible polymeric film for containers for containing acidic material, which film generates carbon dioxide gas when in contact with the acidic material to settle in the headspace of the container.

The acidic material may typically be acidic foodstuffs such as wine and fruit juice. Typically, the container can be selected from the bag in a box type of container.

The film may include one or more layers. In the case of more than one layer, the inner layer which is in contact with the acidic material will be active and generate carbon dioxide gas.

At least one layer may be a barrier layer. A barrier layer provides a barrier against fluids.

The active film or layer may be derived from olefins or biopolymers, preferably polyethylene. The active film or layer may also include a metal carbonate to form a (Polymer/MCO₃) composite, preferably a polyethylene metal carbonate (PE/MCO₃) and more preferably a polyethylene calcium carbonate (PE/CaCO₃) composite.

The MCO₃ particles may be up to a few micron-size range and incorporated into the polymer. Preferably, the MCO₃ particles may be between 1 and 10 micron, and more preferably about 5 micron.

The concentration of the MCO₃ may be selected to complement the intended product to be packaged by releasing the optimum amount of carbon dioxide.

A blend of Linear Low Density Polyethylene (LLDPE) and Low Density Polyethylene (LDPE) and MCO₃ may be produced by melt extrusion before a film blowing process. The ratio of LLDPE to LDPE may be between 80:20 and 90:10. Apart from the feeding zone (set at 120° C.), the temperatures of the rest of the extrusion process zones including the die can be 160-180° C., in this particular instance it is 160° C. The feed rate and screw speed are maintained at 3.5 kg/h and 202 rpm, respectively. It is to be appreciated that PE has a good resistance to tartaric, malic citric and lactic acids.

The inner layer, which may be blended from Linear Low Density Polyethylene (LLDPE) and Low Density Polyethylene (LDPE), may be produced by melt extrusion before a film blowing process. The ratio of LLDPE to LDPE may be between 80:20 and 90:10, preferably 85:15.

The batch of polyethylene or polyethylene blend may be mixed with a selected weight of MCO₃ particles to give a certain weight percentage of MCO₃ in a range of between 15 and 35 weight percent, preferably selected from 20, 25 and 30 weight percent.

The inner active layer of the film may be separate from an outer layer to form an active layer container or bag inside the outer layer.

Alternatively, the layers of the film may be laminated and may respectively comprise different polymers or composite polymers.

An outer layer may be a composite passive barrier layer, which includes nanoclay particles.

The composite passive barrier may be polyamide (PA) based. The nanoclay particles may be mixed with the PA and extruded to form the nano composite (PA PNC). The nanoclay can be a bentonite and preferably a Montmorillonite. The nanoclays particle size may be between 50 nm and 1 micron in width and length and preferably below 500 nm. The nanoclays may be between one silicate layer of about 1 nm thickness or may constitute a stack of up to 10 layers of 10 nm thickness but preferably between 1 and 5 layers.

The film may include a PA layer on its operatively outer side and functions as a physical barrier to gas permeation and is not in contact with the foodstuffs.

The film may include suitable tie layers, preferably, Polyacrylic acid (PAA) layer between the active barrier layer and the composite passive barrier layer.

In one embodiment, PA PNC is prepared via a masterbatch dilution technique. The processing temperatures for different extrusion zones are selected at 120, 200, 260, 260, 260, 260, 260, 250, 245, 240 (die) ° C. The feed rate and the screw speed were 4.4 kg/h and 156 rpm, respectively. According to thermogravimetric analysis (TGA) the inorganic/silicate content of masterbatch is 23 wt %. PA PNC with desired amount of nanoclay can then be prepared by diluting this masterbatch in neat PA. The inorganic content of PA PNC (determined by TGA) is 7 wt %. Before processing, PA and nanoclay were dried at 60° C. overnight and the processed samples were also dried at the same conditions.

The respective layers may be separated, laminated or co-extruded.

Some embodiments also extend to a container constructed from a film as described above.

Some embodiments also extend to a method of constructing a film as described above or elsewhere herein.

### BRIEF DESCRIPTION OF THE DRAWINGS

FIG. 1(a)-(e) show scanning electron microscope (SEM) images captured on the freeze-fractured cross-sections of the films presented as examples.

FIG. 2 provides a graphical representation of CO₂ (volume) released over time.

FIG. 3 provides a depiction of different configurations and embodiments of a bag in a box application.

FIG. 4 provides photographs of a bottle-tube displacement set-up for the quantification of carbon dioxide released from the film containing PE active as inner layer.

### DETAILED DESCRIPTION

According to the some embodiments, provided herein is a composite active flexible polymeric film for containers for containing acidic material. In some embodiments, the film generates carbon dioxide gas when in contact with the acidic material to settle in the headspace of the container. In some embodiments, the film solves one or more problems in the field of containers.

The traditional function of a packaging is to encase or contain food products to limit the ingress from elements outside the package, which may cause degradation and spoilage. US patent application 2009/0324979A1 discloses multilayer film structures comprising polyethylene (PE)-CaCO₃ as a core and outer layer. The CaCO₃ in that patent is either steric or palmitic acid coated. Moreover, a salt of polyacrylic acid and/or a salt of copolymer of acrylic acid have been used as a grinding aid during wet-grinding of CaCO₃ after surface modification. One or more layers of ethyl vinyl acetate (EVA), ethylene ethyl acetate (EEA), ethylene acrylic acid (EAA) have been used as an inner layer to promote sealing. The authors have claimed that the moisture vapour transmission rate reduces in the presence of CaCO₃. Not only that, but also, the surface roughening effect enhances the printability and print register. Addition of CaCO₃ has been shown to lower the coefficient of friction too.

EP 1439956 A1 relates to bi-oriented multi-layered PE films having high water-vapour transmission rate. The base layer (central layer) comprises of PE with CaCO₃ as a captivating agent. This layer has been sandwiched between a copolymer (ethylene-propylene co-polymer or ethylene-propylene-butylene ter-polymer) or hydrocarbon resin (e.g. terpene, styrene and cyclopentadiene). The authors claimed that may have unidirectional tear properties in the machine direction and may be useful for packaging food products like candy.

Preparation of breathable micro-porous film by stretching a casting of a composition of a LLDPE (linear low density PE) and CaCO₃ and calcium stearate in two directions has been disclosed in U.S. Pat. No. 5,011,698. Such microporous film is desired for disposable items e.g. diapers, bed-sheets, and hospital gowns. LDPE (low density PE)-CaCO₃ has also been used to prepare cross-tearable decorative sheet material as disclosed in U.S. Pat. No. 4,298,647. In U.S. Pat. No. 4,219,453 it has been demonstrated that inorganic filler (e.g. CaCO₃) containing ethylene polymers (can be homo and co-polymers) exhibit improved mechanical strengths (impact and tear) in presence of steric and palmitic acid mixtures (1:1), zinc stearate and 2,6-di-ter-butyl-p-cerol. None of these disclosures reports the use of polymer/CaCO₃ composite as an inner functional layer for suppression of oxygen through generation of CO₂ into the headspace and in the packaged acidic liquid.

One report is available on the PA PNC/tie/PE; where Cloisite30B and Dellite 43B nanoclays were used to prepare PA PNC. LDPE-g-MA was used as a tie layer. This report can be found at: Garofalo E, Scarfato P, Incarnato L. Tuning of co-extrusion processing conditions and film layout to optimize the performance of multilayer nanocomposite films for food packaging. Polymer Composites, 2017, DOI 10.1002/pc.24323.

Some embodiments disclosed herein provide a novel film construction that comprises the innovatively utilized PE/CaCO₃ composite inner layer and passive barrier layer based on South African nanoclays (Betsopa™).

Some embodiments are now described by way of example with reference to the accompanying images.

A blend of Linear Low Density Polyethylene (LLDPE) and Low Density Polyethylene (LDPE) is produced by melt extrusion before a film blowing process. The ratio of LLDPE to LDPE is 85:15.

The CaCO₃ particles are in the micron to nano sized range, in some embodiments, less than or equal to about 5 micron. In some embodiments, the PE Active composite is prepared by mixing the blend of LLDPE and LDPE before extrusion with equal to or less than about: 20, 25 and 30 weight percent of CaCO₃ (or ranges including and/or spanning the aforementioned values) to obtain different CaCO₃ loaded films.

In some embodiments, apart from the feeding zone (set at equal to or less than 120° C.), the temperatures of the rest of the extrusion process zones including the die can be equal to or at least about 160-180° C.; in this particular instance it is 160° C. In some embodiments, the feed rate and screw speed are maintained at equal to or at least about 3.5 kg/h and 202 rpm, respectively. It is to be appreciated that PE has a good resistance to tartaric, malic citric and lactic acids.

In some embodiments, the nanoclay particles of the composite passive barrier is mixed with the PA and extruded to form the nanocomposite (PA PNC)

In some embodiments, the PA PNC can be prepared via a masterbatch dilution technique and by direct incorporation of nanoclay with specific loading.

In one instance, PA PNC is prepared via a masterbatch dilution technique. The processing temperatures for different extrusion zones are selected at 120, 200, 260, 260, 260, 260, 260, 250, 245, 240 (die) ° C. (or ranges including and/or spanning the aforementioned values). The feed rate and the screw speed were 4.4 kg/h and 156 rpm, respectively. According to thermogravimetric analysis (TGA) the inorganic/silicate content of masterbatch is 23 wt %. PA PNC with desired amount of nanoclay can then be prepared by diluting this masterbatch in neat PA. In some embodiments, the inorganic content of PA PNC (determined by TGA) is 7 wt %. In some embodiments, before processing, PA and nanoclay may be dried at 60° C. overnight and the processed samples were also dried at the same conditions.

In some embodiments, a co-rotating twin-screw extruder, with L/D of 40 and a die diameter of 3 mm) is used for processing and extruded samples are collected via a water bath and then pelletized.

In some embodiments, the respective films are either single- or multi-layered co-extruded blown films.

In some embodiments, the main objective and/or an advantage of the invention is the controlled release of CO₂ from the PE active film, to enhance the shelf life of beverages containing fruity acids by displacing dissolved oxygen from the liquid and creating a positive pressure. In some embodiments, other problems are solved.

In some embodiments, single-layer PE Active with varied concentration of CaCO₃ and neat PE films demonstrate that PE Active can release CO₂ when in contact with fruity acid such as tartaric acid.

In some embodiments, PE Active layer is also integrated in a multi-layered film by addition to PA PNC which provides passive oxygen barrier.

### Example 1

Single-layer PE Active with 20% CaCO₃ (Example 1). The composition of the film and the key film processing parameters are tabulated in Table 1 (below). The scanning electron microscope (SEM) image captured on the freeze-fractured cross-sections of the film is presented in FIG. 1a. The circular patterns represent the dispersed CaCO₃ particles. The CaCO₃ embedded active films generates CO₂ while in contact with acidic fluid over a period of time and eventually create a positive pressure inside the pouch/container and block the permeation of oxygen from the atmosphere. It was found that incorporation of CaCO₃ does not affect the inherent sealing properties of PE.

Quantification of release of CO₂ gas is determined by bottle-tube displacement experiments (refer to APPENDIX-A) from the reaction of the tartaric acid solution with the experimental film. The graphical representation of CO₂ (volume) released over time is presented in FIG. 2. It is evident that over time, tartaric acid penetrates the film, reacts with CaCO₃ in the film, and releases CO₂. The neat PE film containing 85% LLDPE and 15% LDPE does not exhibit such CO₂ release capability. In most cases, the visible change is noticeable approximately after 4 days.

### Example 2

Single-layer PE Active with 25% CaCO₃ (Example 2) shows the effect of CaCO₃ concentration of the particles on the CO₂ release. The composition of the film and the key film processing parameters are tabulated in Table 1 (below). The SEM image captured on the freeze-fractured cross-sections of the film is presented in FIG. 1b. It is evident from the figure that reactive sites increase with the loading of CaCO₃. As a result, the release of CO₂ increases (refer to FIG. 2). Therefore, it is to be expected that as the concentration of CaCO₃ increases, more CaCO₃ particles will be available for the reaction with acid in the contained foodstuffs.

### Example 3

Further concentration of CaCO₃ is increase to 30% in the single-layer PE Active film (Example 3). The composition of the film and film processing parameters are tabulated in Table 1 (below). The SEM image captured on the freeze-fractured cross-sections of the film is presented in FIG. 1c. It is evident from the figure that the surface roughness increases with the loading of CaCO₃ and more sites are available for the targeted reaction. Subsequently, the release of CO₂ increases as observed in FIG. 2. The contact area can be manipulated by loading of CaCO₃ and/or by process induced porous structure formation.

### Example 4

PE active (similar as EXAMPLE 2) composite is integrated in a multi-layered active-passive barrier film where the dispersed nanoclays in PA PNC retards the ingress of oxygen by creating tortuosity (Example 4). The composition of the film and the key film processing parameters are tabulated in Table 1 (below). The SEM image captured on the freeze-fractured cross-sections of the film is presented in FIG. 1d. Presence of multiple layers are clearly visible in FIG. 1d and the thickness of PE active layer is approximately 32 μm. The volume of CO₂ released from the film is presented in FIG. 2. The multi-layered structure is the less reactive than the single layered films containing different concentration of CaCO₃ (EXAMPLES 1-3). However, it exhibits slow release of CO₂ over time. The amount of CO₂ that will be released over 1, 3 and 6-month period is estimated using a curve fitting of polynomial of order 2. The estimated CO₂ release from the film after 1, 3, 6-month are 6, 22 and 146 ppm, respectively. Such concentration of CO₂ falls within the prescribed limit. For the safety reason, in case of BIB package the amount of CO₂ specified is <600-800 ppm. Above 600-800 ppm the bag may swell when the temperature rises as the CO₂ comes out of solution.

CO₂ becomes perceptible to the human palate at around 1 g/l, which creates a slight spritz on the tongue. The recommended concentrations of CO₂ (at 20° C.) in still, semi-sparkling and the sparkling wines are <2 g/l, 2 to 5 g/l and >6 g/l, respectively. According to wine makers, CO₂ limit in sauvignon blanc and aromatic whites, Chardonnay and red wines are respectively 1000-1100, 800 and <500 ppm in and less than 500 ppm. Generally, the accepted concentrations of CO₂ in the red and white wines are different; specifications are about a maximum of 400 ppm for reds and 600-800 ppm for white wines.

Higher concentration of CO₂ gives crisper wine with lower dissolved oxygen, but less flavor intensity. However, a bit of CO₂ helps preserving the wine. Addition of Sulfur dioxide (SO₂) to the wine during fermentation is a common practice to extend the shelf-life. SO₂ itself is a gas, but readily reacts with water and forms bisulfite/sulfite. The formation of sulfite depends on the pH of water. It increases logistically with increase in pH. This sulfite binds to the anthocyanins, a phenolic molecule that gives red color to the wine. As a result, the SO₂ containing red wines have less intense color. This reaction reduces the chance of reaction between the anthocyanin and the dissolved oxygen. The reaction between anthocyanin and the dissolved oxygen produces acetaldehyde and gives wine a brownish hue. The level of free SO₂ upon filling is often 25-50 ppm. However, it falls over time; the free left after 9 months can be 12 ppm. SO₂ can prevent wine oxidation, but it can have adverse allergic effects. Since CO₂ as a blanket over the surface of wine can help prevent oxidation and the growth of spoilage organisms, a slow release of CO₂ over time can compensate the loss of SO₂ and prolong the shelf life of wine. Not only that, it might allow reduction of the initial SO₂ concentration to reduce the health risk.

Typical properties of the multi-layered active-passive barrier film is summarised in Table 2. The typical oxygen permeation for the film is 1.49 cc-mm/m²·day at 0% RH. In comparison to the Comparative example, where neat PA is used as a passive barrier instead of PAPNC, there is approximately 51% reduction in oxygen permeation. The transparency of the film is measured using UV-Vis spectrometer and the transmittance before and after exposure to humidity (37% RH, 30° C. for 24 h) are respectively 89.47% and 89.02%. As depicted in Table 2, replacing PA by PA PNC does not have any effect the transparency of the film. Overall, tensile properties of the multi-layered active passive barrier film is also better than the comparative example.

Safety and migration of nanoparticles from the packaging film is of utmost importance in any application. Migration of nanoclay constituents from the co-extruded multi-layered films (Example 4 and Comparative example) are presented in Tables 3 and 4 (below). Inductively coupled plasma mass spectroscopy (ICP-MS) and graphite furnace atomic spectroscopy (GFAAS) have been used to quantify the amount of inorganic contents (Mg, Al, and Si are used as main markers) migrated into Type C simulant (Following EU10/2011 regulatory procedure) recommended for high alcohol containing food and beverages. Whereas High performance liquid chromatography (HPLC) coupled with MS has been employed to quantify the organic content migrated from the representative films. The effect of storage time of the film prior to the exposure to the simulant is investigated. The concentration of Mg, Al and Si migrated from the films to the simulant are tabulated in Table 3 (below). The point to be noted is that according to Swiss Ordinance from the Federal Department of Home Affairs FDHA Federal Food Safety and Veterinary Office FSVO Annex 10 of the Ordinance of the FDHA on materials and articles intended to come into contact with food-stuffs, List of permitted substances for the production of packaging inks, and related requirements, 2017, nanoclay is recognised as a class-A material and safe. For class-B material, the default specific migration limit is 0.01 ppm. Some results indicate that no nanoclay compositions are below detection limit (BDL) or in the range of ppb concentration. In addition, presence of porous active inner layer does not induce migration of clay constituents into food simulant.

HPLC-MS results are summarized in Table 4 (below). Migration concentration trend of precursor ions from the surfactant used to modify the nanoclay with storage time is quite stable and is not expected to give rise to safety concerns of estimated 50 μg·kg⁻¹ or 0.05 ppm of dimethylalkyl (C16-C18) amines migration according to a Food Contact Materials, Enzymes, Flavourings and Processing Aids (CEF) panel, see EFSA Panel on Food Contact Materials, Enzymes, Flavourings and Processing Aids (CEF). EFSA J. 2015, 13, 4285.

FIG. 3 shows diagrammatically different configurations and embodiments of the bag in a box application of the invention.

### Comparative Example

Multi-layered film comprises of PE Active and PA as a passive gas barrier layer (Comparative example). The composition of the film and the key film processing parameters are tabulated in Table 1 (below). The typical oxygen permeation for the film is 3.07 cc-mm/m²·day at 0% RH. The transparency of the film is measured using UV-Vis spectrometer and the transmittance before and after exposure to humidity (37% RH, 30° C. for 24 h) are respectively 88.88% and 88.17%. The tensile properties of the film is also reported in Table 2 (below) and the film exhibits similar properties in both machine and transverse direction.

The film in comparative example is used as a control to quantify the migration of nanoclay constituents from the film presented in EXAMPLE 4. Though the comparative example does not contain nanoclay, there are some traces of Mg, Al, and Si detected in GFAAS. Such result may originate from instrument error and/or sampled deionised water.

TABLE 1
The composition of the film and the key film processing parameters.

| | | | | Film |
|---|---|---|---|---|
| | | Screw speed | Temperature | thickness |
| Film codes | Material | (rpm) | (° C.) | (μm) |
| Example 1 | [symbol] LLDPE - 12% LDPE/20% CaCO [symbol] | 40 | [symbol] | [symbol] 0 |
| Example 2 | [symbol] LLDPE - 11.25% LDPE/25% CaCO [symbol] | 40 | [symbol] | [symbol] 0 |
| Example 3 | 59.5% LLDPE - 10.5% LDPE/30% CaCO [symbol] | 80 | [symbol] | 57 |
| Example 4 | LD-LLD PE/25% CaCO [symbol] | 75 | [symbol] | [symbol] 8 |
| | PAA | 15 | [symbol] | |
| | PA PN [symbol] | 35 | [symbol] | |
| | PA | 15 | [symbol] | |
| Comparative | LD-LLD PE/25% CaCO [symbol] | 75 | [symbol] | 60 |
| example | Poly acrylic acid ( [symbol] ) | 15 | [symbol] | |
| | PA | 35 | [symbol] | |
| | PA | 15 | [symbol] | |

[symbol]

indicates data missing or illegible when filed

TABLE 2
The properties of the mufti-layered films.

| | | Transparency | | | | | | | |
|---|---|---|---|---|---|---|---|---|---|
| | | | after moisture | | | | | | |
| | | | exposure | | | | | | |
| | Oxygen | before | (37% rh, | Tensile -machine direction | | | Tensile -transverse direction | | |
| | permeation | moisture | 30° C. for | Modulus | Load at | Stress at | Modulus | Load at | Stress at |
| Film code | (cc-mm² · day) | exposure (%) | 24 h) (%) | (MPa) | yield (N) | yield (MPa) | (MPa) | yield (N) | yield (MPa) |
| Example 4 | 1.49 | 89.47 | 89.02 | 589 ± 74.1 | 43.5 ± 3.9 | 31.1 ± 2.8 | 560.7 ± 18.38 | 29.8 ± 1.7 | 21.3 ± 1.2 |
| Comparative | 3.07 | 88.88 | 88.17 | 399.4 ± 54.1 | 23.4 ± 1.7 | 16.2 ± .2 | 408.4 ± 59.93 | 22.1 ± 2.1 | 15.8 ± 1.5 |
| example | | | | | | | | | |

TABLE 3
Migration of inorganic compositions of Bentonite nanoclay from
the multi-layered films determined by ICP-MS and GFAAS.

| | ICP-MS | | | | |
|---|---|---|---|---|---|
| | Mg (ppb) | Al (ppb) | GFAAS | | |
| Sample | [symbol] * = 0.0402 ppb | [symbol] = 0.2324 ppb | Mg (ppb) | Al (ppb) | Si (ppb) |
| Comparative example - as prepared | BDL** | BDL | 54.25 ± 1.3 | 4.76 ± 0.1 | 400.4 ± 43.36 |
| Comparative example - 3 m | BDL | BDL | BDL | 2.42 ± 0.5 | 369.9 ± 22.82 |
| Comparative example - 6 m | 961 | BDL | 2.95 ± 0.2 | BDL | 157.3 ± 36.93 |
| Example 4 - as prepared | 312 ± 0 | 458 ± 0 | 57.74 ± 9.7 | 403.4 ± 112.7 | 678.0 ± 262.4 |
| Example 4 - 3 m | BDL | BDL | 55.81 ± 2.4 | 2.50 ± 0.1 | 741.0 ± 43.73 |
| Example 4 - 6 m | BDL | BDL | 25.00 ± 0.1 | 3.42 ± 0 | 326.6 ± 28.82 |

* [symbol] : Limit of detection:
**BDL: Below detection limit of the instrument

TABLE 4
The surfactant precursor ions determined
in the migrant simulant by HPLC.

| | C₁₆C₁₆ | C₁₆C₁₈ | C₁₈C₁₈ |
|---|---|---|---|
| Migrant in contact with films | (ppm) | (ppm) | (ppm) |
| Comparative example -as prepared | BDL | BDL | BDL |
| Example 4 -as prepared | 1.93 | 0.0881 | 1.83 |
| Example 4 - 3 m | BDL | BDL | BDL |
| Example 4 - 6 m | 0.0152 | BDL | BDL |

### APPENDIX-A

### Experimental Set-Up of Bottle-Tube Displacement

The most prevalent acids found in wine are tartaric acid, malic acid, and citric acid and concentration of these fruity acids in wine at harvest are 2.5-5, 1-4, and <1 g/l, respectively. Among them tartaric acid is the preferred one since it is stable against microbial degradation. Malic acid can degrade to lactic acid and citric acid to diacetyl and acetic acid and give buttery aroma to some wines. Hence, in this study 1% tartaric acid solution has been considered as a simulant of wine to study the CO₂ release due to the reaction of tartaric acid with the active layer of the multi-layered film. A typical experimental set-up of bottle-tube displacement in order to determine the CO₂ release is presented in FIG. 4. The set-up was then placed to be stationary where it cannot be easily interrupted so that any movement of the drop/bubble in the tube is due to the pressure change occurring in the head space of the pouch. Such movement of bubble is believed to be due to the release of CO₂ from the reaction of the tartaric acid solution and the PE/CaCO₃ film liner. In a separate experiment (lime water test), the release of CO₂ has been confirmed. The headspace was kept constant at 2.2% irrespective of pouch volume. The displacement (D) of the drop/bubble was then measured in different time intervals, and the volume of the gas was estimated according to the equation 1.

V=πr²D [1]

Where, r is the inner radius of the tube and D is the measured displacement.

1. A composite active flexible polymeric film for containers for containing acidic material, which film generates carbon dioxide gas when in contact with the acidic material to settle in the headspace of the container, which film comprises a layer of a polymer and metal carbonate composite.

2. The composite film as claimed in claim 1, which comprises more than one layer and wherein the inner layer is in contact with the acidic material being active to generate carbon dioxide gas.

3. The composite film as claimed in claim 1, wherein at least one layer is a barrier layer.

4. The composite film as claimed in claim 1, wherein the active flayer is derived from olefins or biopolymers.

5. The composite film as claimed in claim 1, wherein the active layer is derived from polyethylene.

6. The composite film as claimed in claim 1, wherein the active layer is a polyethylene metal carbonate (PE/MCO₃) composite.

7. The composite film as claimed in claim 1, wherein the active layer is a polyethylene calcium carbonate (PE/CaCO₃) composite.

8. The composite film as claimed in claim 7, wherein the CaCO₃ particles are in the micron to nano sized range and incorporated into the polymer.

9. The composite film as claimed in claim 5, wherein the active layer comprises a blend of Linear Low Density Polyethylene (LLDPE) and Low Density Polyethylene (LDPE) and CaCO₃.

10. The composite film as claimed in claim 5, wherein the film or layer, as the case may be, is produced by melt extrusion before a film blowing process.

11. The composite film as claimed in claim 9, wherein the ratio of LLDPE to LDPE is selected to be between 20:80 and 10:90.

12. The composite film as claimed in claim 7, wherein the weight percentage of CaCO₃ is selected from a range of between 15 and 35 weight percent.

13. The composite film as claimed in claim 2, wherein an inner active layer of the film is separate from an outer layer to form an active layer container or bag inside the outer layer.

14. The composite film as claimed in claim 2, wherein the layers of the film are laminated and respectively comprise different polymers or composite polymers.

15. The composite film as claimed in claim 13, wherein an outer layer is a composite passive barrier layer, which comprises nanoclay particles.

16. The composite film as claimed in claim 15, wherein the composite passive barrier is polyamide (PA) based.

17. The composite film as claimed in claim 14, wherein the film comprises suitable tie layers.

18. A container constructed from a film as claimed in claim 1.

19. A method of constructing a film as claimed in claim 9, which comprises the steps of setting the temperature of the feeding zone at 120° C., the temperatures of the rest of the extrusion process zones including the die at between 160-180° C. and wherein the feed rate and screw speed are maintained at about 3.5 kg/h and 202 rpm, respectively.

20. The method as claimed in claim 19, wherein the batch of polyethylene or polyethylene blend is mixed with a selected weight of CaCO₃ particles to give a certain weight percentage of CaCO₃ in a range of between 15 and 35 weight percent.

21. The method as claimed in claim 19, wherein nanoclay particles is mixed with the PA and extruded to form the nano composite (PNC).

22. The method as claimed in claim 21, wherein the PA PNC is prepared via a masterbatch dilution technique and the processing temperatures for different extrusion zones are selected at 120, 200, 260, 260, 260, 260, 260, 250, 245, 240 (die) ° C., the feed rate and the screw speed are set at 4.4 kg/h and 156 rpm, respectively.
